(19) United States
(12) Patent Application Publication
(10) Pub. No.: US 2002/0076299 A1
(43) Pub. Date: Jun. 20, 2002

(54) Nut and nut holder

(76) Inventor: Matthew J. Ransil, Stevens, PA (US)

Correspondence Address: William Squire, Esq., c/o Carella, Byrne, Bain, Gilfillan, Cecchi,, Stewart & Olstein, 6 Becker Farm Road, Roseland, NJ, 07068, US

(21) Appl. No.: 09/737,071

(22) Filed: Dec. 14, 2000

Related U.S. Application Data
(60) Provisional application No. 60/171,142, filed on Dec. 16, 1999.

(51) Int. Cl. F16B 27/00

(52) U.S. Cl. 411/84

(57) ABSTRACT

An elongated nut holder has an elongated slot formed with a relatively narrow first entrance neck slot portion and a wider internal second slot portion. The second slot portion has a concave circular cylindrical segment bottom surface. A nut has an elongated body with a top flat surface and a bottom convex curved surface complementary to the second slot portion bottom surface curve. The nut has one or more threaded openings in the top surface which may be through holes. The nut has a transverse width greater than the neck slot portion transverse width and less than the slot second portion width so that the nut is retained in the second slot portion. The nut has a height less than the neck slot portion width. The nut has an edge between the top and bottom surfaces which is inserted first through the neck slot portion. The nut curved surface engages the nut holder curved surface which rotate the nut so that the nut flat surface and threaded opening(s) face the neck slot portion. A threaded fastener is attached to the nut threaded openings through the neck slot portion.

This invention relates to a nut, as well as a nut holder. This invention further relates to a combination of a nut and a nut holder.

There presently exists in the art a nut known as a “T” nut, which is received in a nut holder that includes a “T”-shaped slot. In order to insert the nut in the nut holder, it is necessary to slide the T-shaped nut into the holder through the end of the T-shaped slot.

In accordance with the present invention, there is provided an improved nut, an improved nut holder, and an improved combination of a nut and a nut holder.

More particularly, in accordance with an aspect of the present invention, a nut comprises a body, the body having a top portion and a bottom portion, the bottom portion having a curved surface, said top portion having at least one threaded opening for receiving a fastener.

In one aspect, the body is elongated and has a plurality of said threaded openings.

In a further aspect, the curved surface is convex.

In a further aspect, the curved surface is a segment of a convex circular cylinder.

In a further aspect, the threaded opening extends through the body in communication with the bottom curved surface.

In a further aspect, the threaded opening is blind terminating within the body.

A nut holder according to a still further aspect comprises a body, said body having a slot extending in a first direction, said slot including a first slot portion that is open to the exterior of said body, and a second slot portion that is open to the exterior of said body through said first slot portion, the slot portions each having a width transverse the first direction, the second slot portion having a bottom surface, said first slot portion having a smaller transverse width than the second slot portion transverse width, said second slot portion bottom surface being curved.

In a further aspect, the bottom surface is concave.

In a still further aspect, the bottom surface is a segment of a circular cylinder.

In a further aspect, the body is elongated.

In a further aspect, a combination of a nut and a nut holder, comprises a nut comprising a first body, said elongated body including a top portion and a bottom portion, said bottom portion having a curved surface, said top portion including at least one threaded opening for receiving a fastener. A second body is included, said second body having a slot extending in a first direction, said slot including a first slot portion that is open to the exterior of said second body, and a second slot portion that is open to the exterior of said second body through said first slot portion, the slot portions each having a width transverse the first direction, the second slot portion having a bottom surface, said first slot portion having a smaller transverse width than the second slot portion transverse width, said second slot portion bottom surface being curved.

The nut is located in said slot of said second body with said at least one threaded opening facing said first slot portion of said nut first body, said curved surface of the bottom portion of said nut first body being adjacent to and facing said curved bottom surface of said second slot portion.

In a further aspect, the second body is elongated.

In a further aspect, the first body is elongated and has a plurality of said threaded openings in an array along the length of the first body.

In a further aspect, the curved surface of the nut and the curved surface of the nut holder are complementary.

In a further aspect, the nut curved surface is convex and the nut holder curved surface is concave.

In a further aspect, the curved surfaces are arranged so that engagement of the curved surface of the nut with the curved surface of the nut holder upon insertion of the nut through the first slot portion into the second slot portion rotates the nut relative to the nut holder to orient the threaded opening to face said first slot portion.

As a result, in this manner, unlike a “T” nut, the nut may be inserted into the nut holder at any portion of the slot.

IN THE DRAWING:

The invention will be further described with respect to a preferred embodiment thereof, as illustrated in the accompanying drawings, wherein:

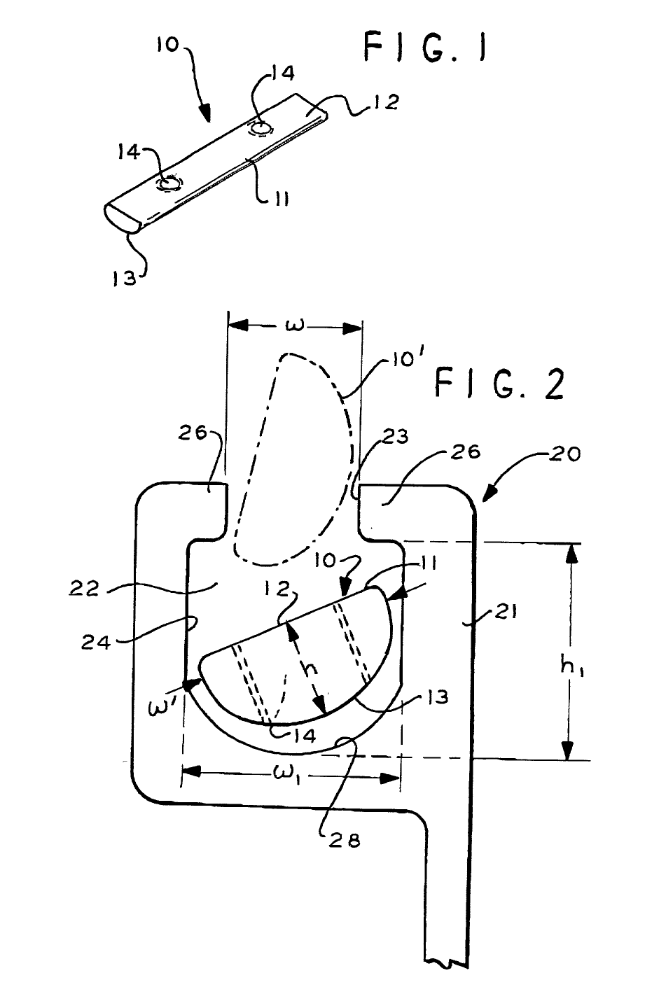

FIG. 1 is a perspective view of a nut of according to an embodiment of the present invention;

FIG. 2 is a sectional elevation view of a nut holder of the invention with the nut of FIG. 1 inserted therein; and

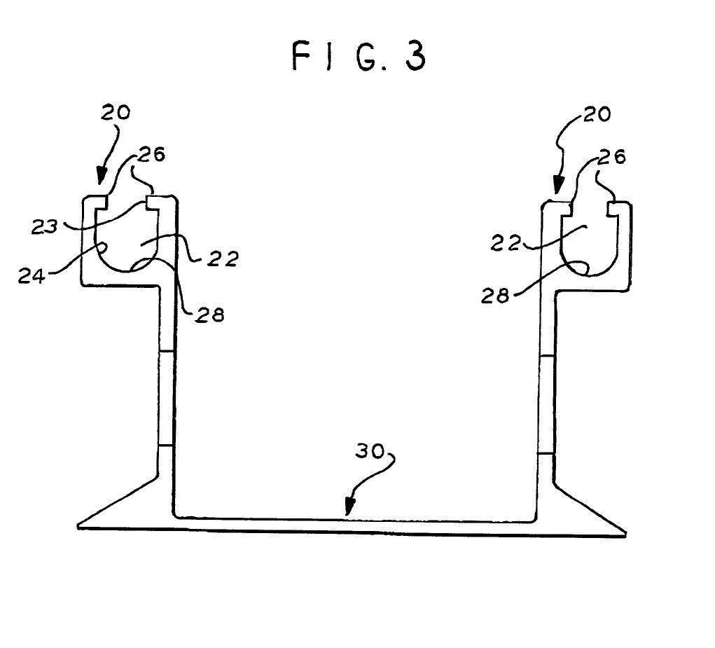

FIG. 3 is a sectional elevation view of an extrusion including nut holders of FIG. 2.

Referring now to the drawings, in FIG. 1, a preferred embodiment of a nut 10 comprises an elongated body 11, having a top surface 12 and a bottom surface 13, with the bottom surface 13 being convex curved.

The top surface 12 may have at least one threaded opening 14 therein, the nut 10 in this embodiment having two threaded through openings 14, both of which pass through the nut body 11. There may be more than two threaded openings 14 according to a given implementation. Also, the threaded openings may be blind holes. While the body is shown elongated it may be foreshortened to receive a single threaded opening 14, the length of the body 12 being of sufficient mass to accommodate that single opening.

In a preferred embodiment, as shown, the top portion surface 12 of the nut 12 is flat, although the invention is not limited to such a flat surface. The bottom surface 13 is preferable a circular segment but may have other curved shapes.

In FIG. 2, nut holder 20 comprises an elongated body 21 that includes an elongated slot 22. The slot 22 has at the top thereof a first open slot portion 23 and at the bottom thereof a second slot portion 24, with the slot portion 23 having a narrower, or smaller, width w (left to right in the drawing) than the slot portion 24. The lower surface 26 of the slot portion 24 is curved concave and is preferably complementary to the curve of surface 13 of the nut 10 for receiving the surface 13.

In accordance with a preferred embodiment, the slot portion 22 is adapted to receive the nut 10, with the width w of the first slot portion 23 being greater than the height h of the nut 10. Further, the width w of the first slot portion 23 is smaller than the width w′ of the nut 10.

The height h₁ of the second slot portion 24 is greater than the width w′ of the nut 10, and the width w₁ of the second slot portion 24 is greater than the width w′ of the nut 10.

As shown in phantom by nut 10′ in FIG. 2, the nut 10 can be inserted into the slot 22 of the nut holder 20 at any point along the length of the nut holder 20 by orienting the nut 10 for insertion into the slot 22 portion 23 of the nut holder 20. In this respect, the nut 10 is inserted into the slot 22 through the slot portion 23 by tilting or rotating the nut 10 so that the nut can fit through the first slot portion 23 via its narrower height h which is smaller than the slot portion 23 width w.

When the nut 10 enters into the second lower slot portion 24, as a result of the engagement of the curved surface 13 of the nut with the curved surface 28 of the bottom surface of the second slot portion 22, the nut is automatically rotated and oriented in a direction such that the top surface 12 thereof faces the slot portion 23 of the slot 22. Thus the threaded portion 14 of the nut 10 faces the slot portion 23 and is accessible to a fastener such as a screw or bolt that is to be inserted into the threaded opening 14.

The nut holder 20 body 21 has inwardly extending flanges 26. These flanges form the relatively narrow slot portion 23 and which overhang and partially enclose the second slot portion 24. The flanges 26 retain the nut 10 in the slot 22 when the nut 10 width w′ is oriented parallel to the width w₁.

Thus, the nut 10 may be inserted into the nut holder at any point along the length thereof, as compared to the prior art “T” nuts, wherein the nut can only be inserted into the nut holder at the end of the slot thereof.

The nut holder may be employed in any one of a wide variety of structures. As shown in FIG. 3, the nut holder 20 is formed as part of an extrusion 30. In FIG. 3, the extrusion 30 includes a nut holder 20 at each of opposite sides of the extrusion. Thus other structures may be connected to the extrusion by insertion of one or more nuts 10 (not shown in FIG. 3) into each nut holder 20. Preferably one nut is used for each nut holder and the nut is thus elongated to correspond to the length of the mating nut holder. An appropriate threaded fastener secures the structure (not shown) to the extrusion 30 by screwing the fastener into the nut threaded opening 14 in the slot 22 of the nut holder.

Numerous modifications and variations of the present invention are possible in light of the above teachings.

What is claimed is:

1. A nut comprising:
a body, the body having a top portion and a bottom portion, said bottom portion having a curved surface, said top portion having at least one threaded opening for receiving a fastener.

2. The nut of claim 1 wherein the body is elongated and has a plurality of said threaded openings.

3. The nut of claim 1 wherein the curved surface is convex.

4. The nut of claim 1 wherein the curved surface is a segment of a convex circular cylinder.

5. The nut of claim 1 wherein the threaded opening extends through the body in communication with the bottom curved surface.

6. The nut of claim 1 wherein the threaded opening is blind terminating within the body.

7. A nut holder, comprising:
a body, said body having a slot extending in a first direction, said slot including a first slot portion that is open to the exterior of said body, and a second slot portion that is open to the exterior of said body through said first slot portion, the slot portions each having a width transverse the first direction, the second slot portion having a bottom surface, said first slot portion having a smaller transverse width than the second slot portion transverse width, said second slot portion bottom surface being curved.

8. The nut holder of claim 7 wherein the bottom surface is concave.

9. The nut holder of claim 8 wherein the bottom surface is a segment of a circular cylinder.

10. The nut holder of claim 7 wherein the body is elongated.

11. A combination of a nut and a nut holder, comprising:
a nut comprising a first body, said elongated body including a top portion and a bottom portion, said bottom portion having a curved surface, said top portion including at least one threaded opening for receiving a fastener;
a second body, said second body having a slot extending in a first direction, said slot including a first slot portion that is open to the exterior of said second body, and a second slot portion that is open to the exterior of said second body through said first slot portion, the slot portions each having a width transverse the first direction, the second slot portion having a bottom surface, said first slot portion having a smaller transverse width than the second slot portion transverse width, said second slot portion bottom surface being curved;
said nut located in said slot of said second body with said at least one threaded opening facing said first slot portion of said nut first body, said curved surface of the bottom portion of said nut first body being adjacent to and facing said curved bottom surface of said second slot portion.

12. The combination of claim 11 wherein the second body is elongated.

13. The combination of claim 12 wherein the first body is elongated and has a plurality of said threaded openings in an array along the length of the first body.

14. The combination of claim 11 wherein the curved surface of the nut and the curved surface of the nut holder are complementary.

15. The combination of claim 14 wherein the nut curved surface is convex and the nut holder curved surface is concave.

16. The combination of claim 11 wherein the curved surfaces are arranged so that engagement of the curved surface of the nut with the curved surface of the nut holder upon insertion of the nut through the first slot portion into the second slot portion rotates the nut relative to the nut holder to orient the threaded opening to face said first slot portion.

17. The combination of claim 11 wherein the first and second bodies are elongated.
